(19) United States
(12) Patent Application Publication
(10) Pub. No.: US 2010/0148489 A1
(43) Pub. Date: Jun. 17, 2010

(54) TUBE CONNECTION HAVING AN ARMATURE HOUSING

(76) Inventors: Franz Johann Pohn, Voecklabruck (AT); Christian Berger, Lambach (AT)

Correspondence Address: COLLARD & ROE, P.C., 1077 NORTHERN BOULEVARD, ROSLYN, NY, 11576, US

(21) Appl. No.: 12/452,721

(22) PCT Filed: Mar. 18, 2008
(86) PCT No.: PCT/EP2008/002136

§ 371 Date: Jan. 26, 2010

(30) Foreign Application Priority Data
Jul. 20, 2007 (AT) A 1160 2007
Feb. 18, 2008 (AT) A 259 2008

(51) Int. Cl. F16L 47/02; F16L 21/03; F16L 33/18

(52) U.S. Cl. 285/21.2; 285/232; 285/37

(57) ABSTRACT

Tube connection (1) for pullout-resistant connection of an insertion end (2) of a tube (3) to a connection sleeve (4), with a retention ring (18) encompassing the insertion end (2) at the circumference and is disposed in an inner groove (12) of the connection sleeve (4), wherein the insertion end (2) projects beyond the retention ring (18) by an excess length (25) in the insertion direction of the tube, and a sealing ring (34), preferably a lip sealing ring (35), which circumferentially encompasses the insertion end (2) is disposed in a ring groove (33), adjacent to the ring groove (12) and at a distance from it in the insertion direction of the tube end, and the connection sleeve (4) has a slit-shaped wall cutout (13) that allows radial insertion of the retention ring, over a partial region of the circumference of the sleeve section (11) that has the inner groove (12), wherein the wall cutout (13) extends over a cross-section sector whose inner angle is less than 180°.

The invention relates to a tube connection as described in the preamble of claim 1.

A sleeve tube connection is known from the document DE 103 06 316 A1, in which a sealing ring that surrounds the insertion end of a tube introduced into the sleeve, forming a seal, is disposed in a circumferential accommodation groove of the groove of the sleeve, which ring is composed, in one piece, of a holding region that is coordinated with the geometry of the accommodation groove and a sealing region, whereby the sealing region has a lesser hardness than the holding region. The sleeve has another groove in the face end region, into which groove the retention bolt is inserted, as security to prevent the tube from being pulled out.

Furthermore, from the document U.S. Pat. No. 6,142,484 A, a support and sealing ring consisting of at least two different materials connected with one another, sealing ring is known. The support ring, which is shaped approximately in the shape of a conical ring, is formed from essentially non-elastic material, and the sealing ring composed of an elastically deformable material is molded onto the base surface that is oriented perpendicular to approximately perpendicular to a center axis. The support ring is furthermore provided with reinforcement ribs that project in wedge shape and are distributed over the circumference. The sealing element furthermore has a ring-shaped sealing lip that projects beyond the inner surface, in the direction of the center axis, in a passage bore.

Furthermore, electrical welding sleeves are known, consisting of a sleeve tube made of plastic, for thermally connecting insertion ends of plastic tubes. The sleeve tube has an electrical resistance heating element embedded into the wall, with connectors for supplying electrical energy. The tube ends to be connected are inserted into the sleeve tube, and thermally bonded to face surfaces that lie opposite them, on the one hand, and with the sleeve tube, on the other hand, by means of the melting process.

It is the task of the invention to create a sleeve tube connection that is resistant to tensile stress, with which simple assembly is supposed to be made possible, using different elements that produce the security against the tube being pulled out. It is supposed to be possible to produce the sleeve tube connection even under tight space conditions.

This task of the invention is accomplished by means of the characteristics indicated in the characterizing part of claim 1. The surprising advantage in this connection is that in this way, a tube connection is created that allows optional use of differently configured retention rings, adapted to the case of use, in each instance, both for a non-releasable and a releasable tube connection.

In this connection, embodiments are also possible whereby the retention ring is formed by a plastic ring that can be thermally connected with the insertion end by means of a melting process, and an electrical heating element is disposed in the plastic ring that forms the retention ring. In this way, security to prevent the tube from being pulled out is achieved, to accommodate great pullout forces for a non-releasable tube connection.

According to the other advantageous embodiments, the insertion end can project beyond the retention ring by an excess length in the insertion direction of the tube end. Adjacent to the inner groove, a sealing ring, preferably a lip sealing ring that surrounds the insertion end on its circumference is disposed in a ring groove, spaced apart from the former groove in the insertion direction of the insertion end. The sealing ring is connected with the retention ring and is particularly molded onto it. Furthermore, the sealing ring is formed from a material that demonstrates a greater elasticity as compared with the material of the retention ring. For simple assembly, a tube connection that is both resistant to the tube being pulled out and pressure-resistant is achieved.

However, embodiments in which at least one bridge element that spans the slit-shaped wall cutout in the axial direction and is anchored on both sides of the wall cutout of the sleeve section is provided, which element is releasably attached to the sleeve section, particularly screwed onto it, are also possible, because in this way, space-saving dimensioning of a fitting is achieved, while simultaneously achieving great housing strength.

Furthermore, the retention ring is configured to be elastically deformable in the radial direction. This advantageous embodiment guarantees automatic coaxial centering of the retention ring in the ring groove of the connection sleeve and thus simplification of the assembly process.

The retention ring is provided with gearing-like retention means on an inner circumference surface, which means are formed by molded-in elements, particularly high-strength elements that have a gearing on their inner circumference surface. These retention means consist of a material that has a greater strength than the material of the retention ring, particularly of a metallic material. Furthermore, the retention ring is pressed or can be pressed against the outer tube circumference surface, in the radial direction, by way of a wedge-shaped bracing ring. The wedge-shaped bracing ring is adjustably attached in face-side threaded bores disposed in the connection sleeve, by way of a flange and bracing screws that project through it. A releasable tube connection with a fitting, which can absorb great pullout forces, is achieved by means of the advantageous further developments described in these claims.

The retention ring is formed by arc ring segments, because in this way, an adaptation of uniformly shaped arc segments for tube diameters that vary within a predetermined range is achieved.

The width of the wall cutout approximately corresponds to the width of the inner groove. The slit width of the wall cutout is smaller than the outside diameter of the retention ring. In the case of these advantageous embodiments, almost play-free holding of the insertion end in the connection sleeve is achieved.

Furthermore, the sleeve section can be configured in tubular shape and have not only a circular cross-section but also an oval or polygonal cross-sectional shape. These are advantageous variants for the housing embodiment in the region of the inner groove for the pullout-resistant connection with the tube end.

However, the embodiments in which the retention ring is configured in C shape and has incisions that run radially over a partial region of its width and are distributed over a circumference are also advantageous. In this way, radial elasticity of the retention ring is achieved, to simplify assembly, even in the case of a high-strength material for this ring.

An embodiment in which at least one tension anchor, e.g. screw is disposed in the region of the wall cutout, which anchor runs in the axial direction and connects a bead edge with the sleeve section, and acts for stability of the sleeve section and to guarantee a great resistance strength to pullout forces that occur is also possible.

The retention ring, with the sealing ring molded onto it, is formed by a two-component injection-molded part, and according to the advantageous embodiment described, a retention ring that can be produced in particularly efficient manner for mass production, in terms of production technology, in combination with a sealing ring, is achieved.

The connection sleeve is an integral part of a connection tube and an integral part of a housing such as a valve housing, slide housing, and the like.

Finally, the housing or connection tube is formed from plastic and consists of metallic material, particularly of a cast material. These claims describe advantageous further developments, thereby expanding the range of application of the tube connection to different application cases.

All the aforementioned characteristics can be provided alternatively and in any desired combinations.

For a better understanding of the invention, it will be explained in greater detail, using the exemplary embodiments shown in the figures.

These show:

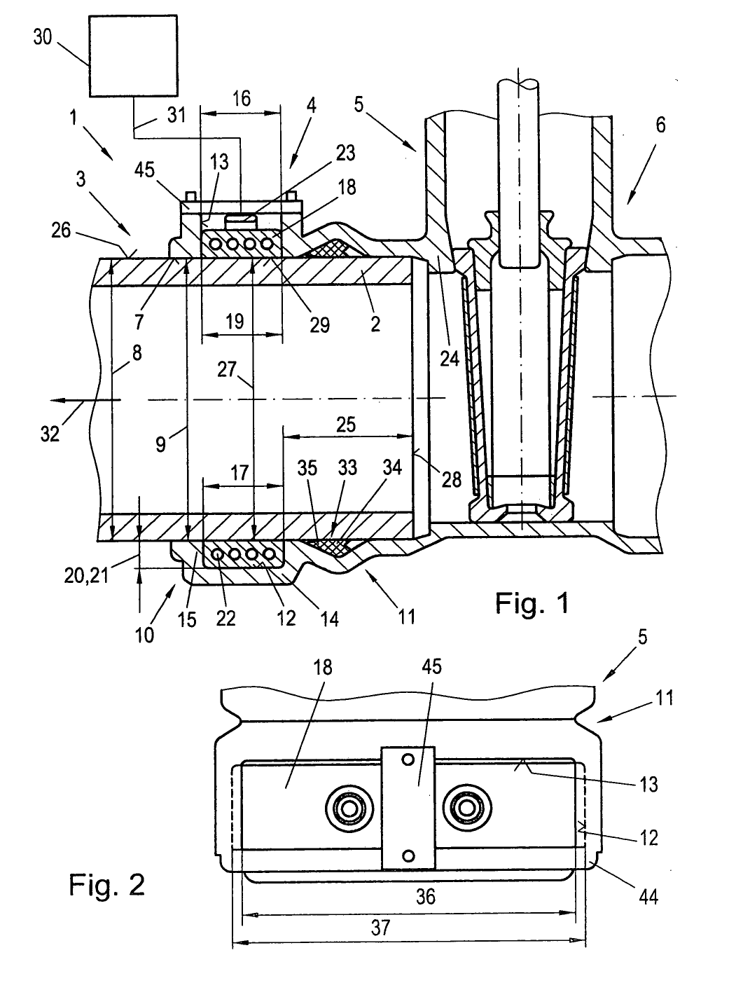

FIG. 1 a tube connection according to the invention, on a connection sleeve of a housing of a slide, in a side view, in section;

FIG. 2 a partial region of the tube connection according to the invention in a top view;

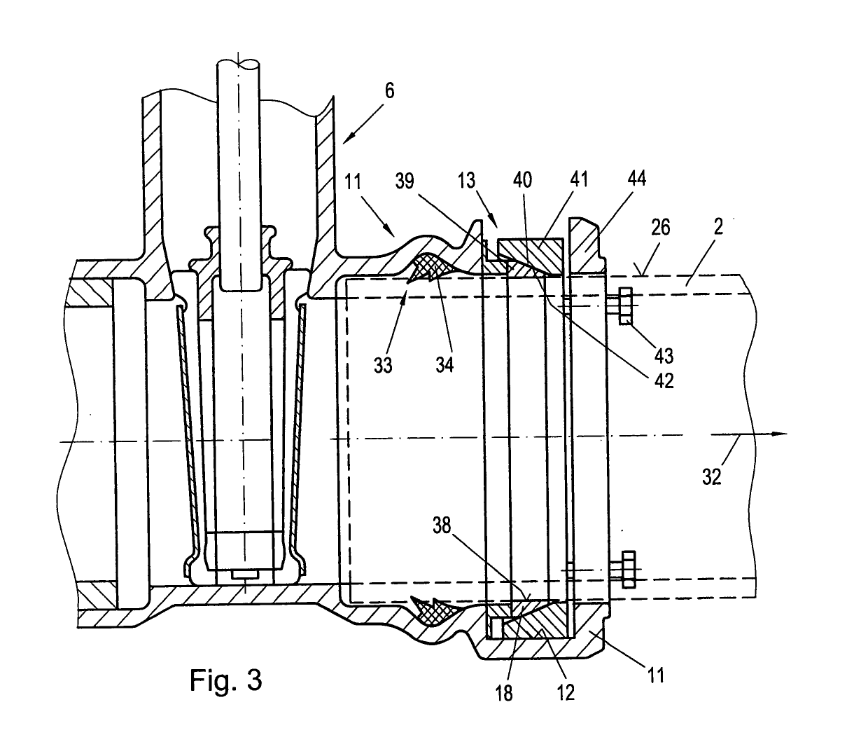

FIG. 3 another embodiment of a tube connection according to the invention, in a side view, in section.

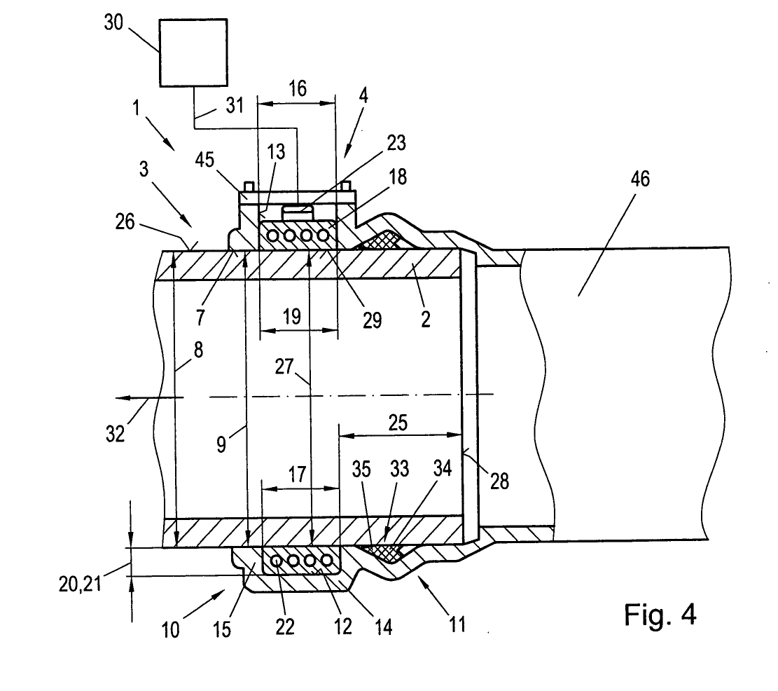

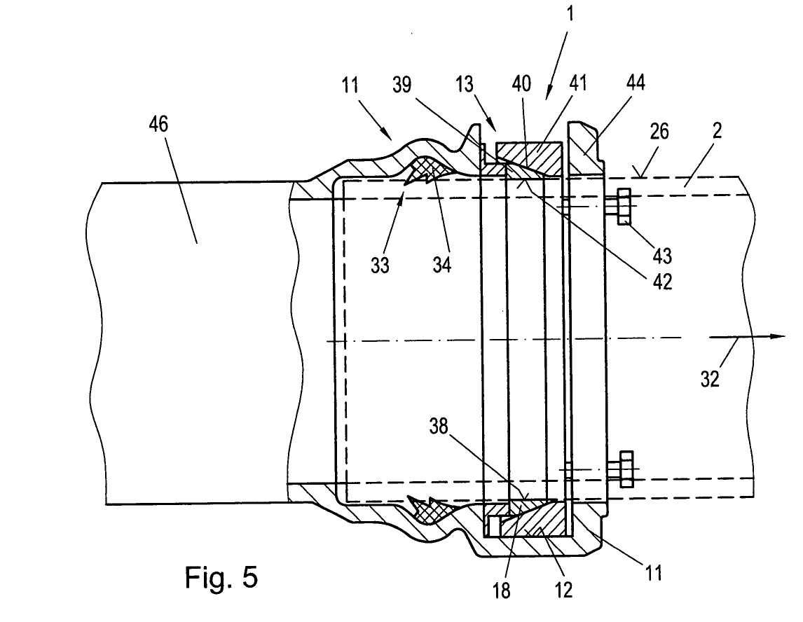

FIGS. 4 and 5 show sectional representations like FIGS. 1 and 3, whereby the connection sleeve sits on a connection tube.

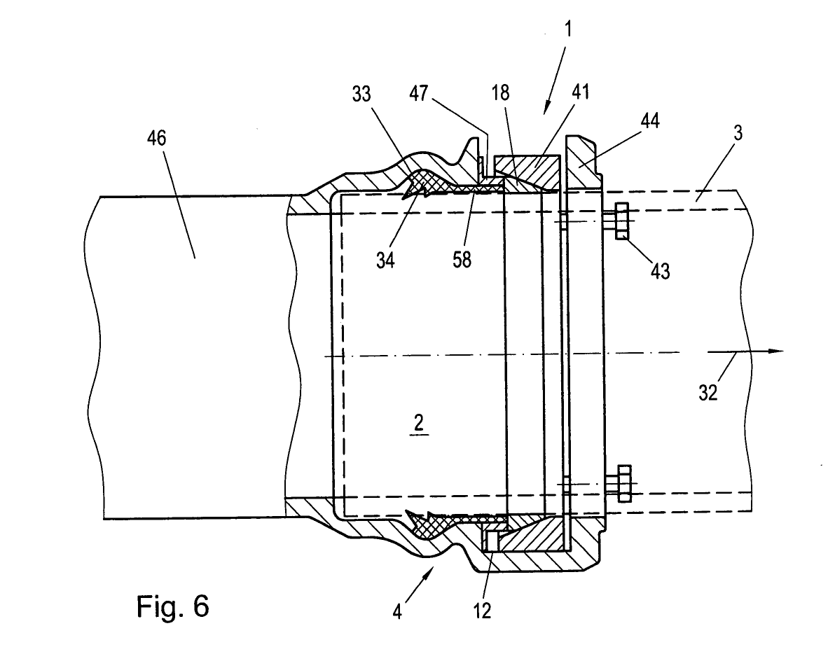

FIG. 6 shows a sectional representation with a special configuration of the sealing ring.

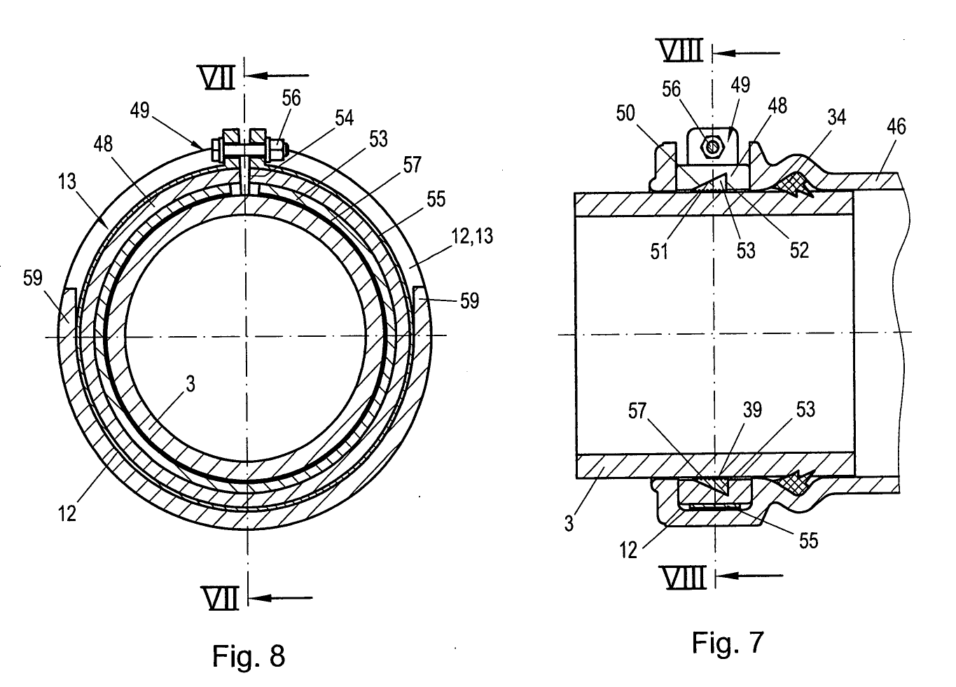

FIGS. 7 and 8 show another embodiment of the retention ring, in two sectional views.

As an introduction, it should be stated that in the different embodiments described, the same parts are provided with the same reference symbols and/or component designations, whereby the disclosures contained in the entire specification can be transferred analogously to the same parts that have the same reference symbols and/or component designations. Also, the position indications selected in the specification, such as top, bottom, to the side, etc., for example, can be related to the figure directly being described and shown, and, in the event of a change in position, should be transferred to the new position.

In FIGS. 1 and 2, a tube connection 1 for connecting an insertion end 2, particularly of a plastic tube 3, to a housing 5 of a slide, which housing has a connection sleeve 4, in such a manner that it cannot be pulled out, is shown.

The exemplary embodiment shown shows the tube connection 1 for connecting the insertion end 2 with the connection sleeve 4 of the housing 5 of a shut-off slide 6, in which the insertion end 2 is accommodated in the sleeve opening 7 so that it cannot be pulled out, and, if necessary, in pressure-tight manner.

The housing 5, together with the connection sleeve 4, is formed by a one-piece component, e.g. from non-metallic or metallic material, particularly as an injection-molded or cast part.

The insertion end 2 of the tube is a so-called smooth pointed end having an outside diameter 8 that is slightly smaller than a diameter 9 of the sleeve opening 7 of the housing 5 in the region of the connection sleeve 4, so that the insertion end can be pushed in.

On a face-side end region 10, the connection sleeve 4 is configured in the shape of a cylindrical or oval or polygonal sleeve section 11, which has an inner groove 12 having an approximately rectangular cross-section.

In the region of the inner groove 12, the sleeve section 11 is provided with a slit-shaped wall cutout 13 extending over a partial region of a circumference. The inner groove 12 is delimited, on the one hand, by a molded-out part 14 of the sleeve section 11 in the direction of the housing 5, and a molded-in part 15 in the axial direction, and the width 16 of the wall cutout 13, measured in the axial direction, is approximately equal to the width 17 of the inner groove 12, according to the exemplary embodiment shown.

The inner groove 12 is designed to accommodate a retention ring 18 that surrounds the insertion end 2 circumferentially, having an approximately rectangular cross-section with a width 19 that is slightly smaller than the width 16 of the wall cutout 13, and with a ring height 20 that corresponds to a groove depth 21 of the inner groove 12, i.e. the retention ring 18 is approximately designed for the cross-section of the inner groove 12, in terms of its dimensioning with regard to its ring width 17 and its ring height 20.

The retention ring 18, in terms of its type, is a so-called plastic weld-on ring that has an electrical resistance heating element 22 with electrical connectors 23 that lead to the outside embedded into its cross-section.

The pullout-resistant tube connection 1 is produced by inserting the retention ring 18 from the outside into the inner groove 12, through the wall cutout 13, and afterwards introducing the insertion end of the tube 2 into the sleeve opening 7 of the housing 5, whereby the insertion end 2 projects beyond the retention ring 18 in the direction of a bore extension 24 in the housing 5, which preferably serves as a delimitation for an excess length 25 of the insertion end 2.

As the result of inserting the insertion end 2 into the sleeve opening 7 of the connection sleeve 4, the retention ring 18 embedded in the inner groove 12 gets onto the insertion end 2, whereby almost play-free fit and full contact with the surface 26 is achieved in that preferably, the inside diameter 27 of the retention ring 18 is slightly smaller than the outside diameter 8 of the insertion end 2.

After the insertion end 2 has been laid against the bore extension 24 in usual manner, with a tube face surface 28 that faces the housing 5, to achieve the excess length 25, a thermal connection process between the retention ring 18 and the insertion end 2 is achieved by means of melting the surface 26 and the ring surface 29 of the retention ring 18 that faces it, in certain regions, by means of providing electrical energy from an energy producer 30 and a line 31 to the resistance heating element 22 of the retention ring 18, and in this way, a non-releasable tube connection 1 that absorbs great pullout forces—in the direction of the arrow 32—is produced.

As can now furthermore be seen in FIG. 1, the sleeve section 11 has another ring groove 33 in the direction of the housing 5, spaced apart from the inner groove 12, in which a sealing ring 34, particularly a lip sealing ring 35, that surrounds the insertion end 2 circumferentially, is disposed, thereby making the tube connection 1 both a pullout-resistant and a pressure-tight connection of the insertion end 2 with the housing 5 of the fitting 6.

As can furthermore be seen in FIG. 2, the wall cutout 13 extends over a partial region of the circumference of the sleeve section 11, whereby the partial region is slightly smaller than half the circumference of the sleeve section 11. As a result, a slit width 36 of the wall cutout 13 is slightly smaller, measured in the radial direction, than the outside diameter 37 of the retention ring 18. In combination with a slight deformability of the retention ring 18 that results from the material, introduction of the retention ring 18 into the inner groove 12, through the wall cutout 13, is nevertheless guaranteed, and this assures a precise coaxial fit of the retention ring 18 relative to the sleeve opening 7, after the ring has returned to its shape, and furthermore guarantees easy assembly.

FIG. 3 shows another embodiment of the tube connection 1 of the insertion end 2 to the slide 6 shown with broken lines. The sleeve section 11 is provided with the slit-shaped wall cutout 13, as has already been described in the preceding figures, and the geometrical configuration of the sleeve section 11 with the wall cutout 13 corresponds to the configuration described above in FIGS. 1 and 2. Also, in FIG. 3 the sealing ring 34, e.g. the lip sealing ring 35, can be seen, which was also already described above, and is provided in the ring groove 33 for a pressure-tight tube connection.

The pullout-resistant connection is achieved by means of the retention ring 18, with retention means 38 provided on an inner circumference surface and facing the surface 26 of the insertion end 2.

Surrounding the retention ring 18 on a cone-shaped extension 40, a wedge-shaped bracing ring 41 having an inner surface 42 that runs conically is provided in the inner groove 12 of the sleeve section 11.

The wedge-shaped bracing ring 41 is adjusted, according to the exemplary embodiment shown, by means of bracing screws 43 that are disposed in threaded bores of a face-side bead edge 44 of the sleeve section 11 and project through this edge, relative to the cone-shaped extension 40 of the support ring 18. In this connection, this extension 40 is pressed against the surface 26 of the insertion end 2 with the retention means 39, in the radial direction, by means of an elastic deformation, whereby the retention means 39, which have a greater strength as compared with the tube material, penetrate into the surface 26, and thus the retention security with regard to a pullout force—according to the arrow 32—is achieved.

It can also be seen in FIG. 2 that in order to minimize the construction dimensions of the housing 5, i.e. of the connection sleeve 4, while guaranteeing that a great pullout force will be absorbed, at least one bridge element 45 that spans the wall cutout 13 in the axial direction can be provided, in advantageous manner, which element is releasably attached, e.g. screwed onto the sleeve section 11, on both sides of the wall cutout 14.

Of course, in place of the bridge element 45, at least one screw that engages into a threaded bore of the sleeve section 11, crossing the wall section 13, can also be provided as a tension anchor, projecting through the bead edge 44 on the face side.

As can be seen in FIGS. 4 and 5, the tube connection according to the invention can advantageously serve to connect tubes that are not directly an integral part of fitting housings. FIGS. 4 and 5 extensively correspond to FIGS. 1 and 3, whereby the same reference symbols indicate the same parts. In place of the housing 5 of the slide 6, the connection sleeve 4 is sitting on a connection tube 46. Otherwise, the description of FIGS. 1 to 3 also applies to FIGS. 4 and 5.

The sectional diagram of FIG. 6 essentially corresponds to that of FIG. 5, whereby it is shown how the sealing ring 34 can be connected with the retention ring 18 and/or the prior spacer element 47 by way of a connection strip 58. The spacer element 47 serves to prevent the retention ring 18 from being pushed in the direction toward the left edge of the inner groove, if the wedge-shaped bracing ring is braced to the left. If the spacer element 47 consists of metal, the sealing ring 34 with its connection strips 58 that consist of rubber can be vulcanized onto the spacer element 47 on the inside. However, the connection strip 58 can also be connected with the retention ring 18.

FIGS. 7 and 8 show another advantageous embodiment of the configuration of a pullout-resistant tube connection, whereby here, as well, a retention ring is disposed in an inner groove 12 of the connection sleeve, and the retention ring as well as the sealing ring can be introduced through a slit-shaped wall cutout.

FIG. 7 shows an axial section through the tube connection along the line VII-VII in FIG. 8.

The tube connection is produced by means of a retention ring, whereby a clamping ring 48 that is laid into the inner groove 12 and set onto the insertion end 2 of the tube 3 is provided. FIG. 8 shows the advantageous configuration of the inner groove 12, which is open toward the top in that the wall cutout 13 is provided, through which tube connection elements, namely here the clamping ring 48, can be pushed in, before the insertion end of the tube 3 is inserted.

It should be emphasized that the wall cutout 13 extends over a cross-section sector whose inner angle is less than 180°. In this way, the inner groove 12, in the closed region, passes over an arc angle that is greater than 180°. In order to facilitate pushing in the connection elements for the tube connection, a tangential flattened region 59 of the groove bottom of the inner groove 12 is provided. However, slight narrowing of the wall cutout 13 can be provided, since the tube connection elements to be pushed in, such as the clamping ring 48 here, is radially slit and therefore variable in its diameter.

The clamping ring 48 has a ring groove 50 in its surface that faces the tube circumference surface, which groove has a shallowly rising wedge flank 51 and a steeply dropping stop flank 52. A wedge-shaped ring 53 is laid into this ring groove 50. The wedge-shaped ring 53 is radially slit, as shown in FIG. 8, and therefore can change its radius. The clamping device 49 provided for the clamping ring 48 comprises a clamping hoop 55 laid around the clamping ring, which hoop has a tension-screw connection 56. By means of tightening the tension-screw connection 56, the radius of the clamping hoop 55 is reduced, and therefore the clamping ring 48 is pressed against the wedge-shaped ring 53, which consists of hard material, particularly of metal or other materials such as plastic, and has retention means 39, particularly a gearing, on its inner circumference surface 57. The teeth of the wedge-shaped ring 53 dig into the material of the insertion end of the tube 3, and thereby produce a pullout-resistant tube connection. If high pullout forces of the tube 3 occur, something that can occur at high pressures of the medium flowing in the tube, then this causes the wedge-shaped ring 53 to run up onto the wedge flank 51, thereby pressing the wedge-shaped ring 53 even more tightly against the tube 3, and thus strengthening the tube connection.

The tube connection according to FIGS. 7 and 8, just like the embodiment according to FIGS. 1 and 2, does not require any bracing forces applied by way of the housing or the tube sleeve. Bracing of the tube connection occurs independent of the housing or tube sleeve.

The exemplary embodiments show possible embodiment variants of the tube connection, whereby it should be noted at this point that the invention is not restricted to the embodiment variants of the invention specifically presented, but rather, various combinations of the individual embodiment variants with one another are possible, and this possibility of variation lies within the ability of a person skilled in the art of this technical field, on the basis of the teaching for technical action provided by the present invention. Also, all possible embodiment variants that are made possible by combining individual details of the embodiment variants shown and described are also covered by the scope of protection.

For the sake of good order, finally, it should be pointed out that for a better understanding of the structure of the tube connection, it and its components have been shown not to scale and/or enlarged and/or reduced in size, in part.

The task on which the independent inventive solutions are based can be derived from the specification.

Above all, the individual embodiments shown in the figures can form the object of independent solutions according to the invention. The tasks and solutions according to the invention, in this regard, can be derived from the detailed description of the figures.

Reference Symbol List

| | |
|---|---|
| 1 | tube connection |
| 2 | insertion end of the tube |
| 3 | tube |
| 4 | connection sleeve |
| 5 | housing |
| 6 | slide |
| 7 | sleeve opening |
| 8 | outside diameter |
| 9 | inside diameter |
| 10 | end region |
| 11 | sleeve section |
| 12 | inner groove |
| 13 | wall cutout |
| 14 | molded-out part |
| 15 | molded-in part |
| 16 | width |
| 17 | width |
| 18 | retention ring |
| 19 | width |
| 20 | ring height |
| 21 | groove depth |
| 22 | resistance heating element |
| 23 | electrical connector |
| 24 | bore extension |
| 25 | excess length |
| 26 | surface |
| 27 | inside diameter |
| 28 | tube face surface |
| 29 | ring surface |
| 30 | energy producer |
| 31 | line |
| 32 | arrow |
| 33 | ring groove |
| 34 | sealing ring |
| 35 | lip sealing ring |
| 36 | slit width |
| 37 | outside diameter |
| 38 | inner surface |
| 39 | retention means |
| 40 | extension |
| 41 | wedge-shaped bracing ring |
| 42 | inner surface |
| 43 | bracing screw |
| 44 | bead edge |
| 45 | bridge element |
| 46 | connection tube |
| 47 | spacer element |
| 48 | clamping ring |
| 49 | clamping device |
| 50 | ring groove |
| 51 | wedge flank |
| 52 | stop flank |
| 53 | wedge ring |
| 54 | radial slit |
| 55 | clamping hoop |
| 56 | tension-screw connection |
| 57 | inner circumference surface |
| 58 | connection strip |
| 59 | tangential flattened region |

1-38. (canceled)

39. Tube connection (1) for pullout-resistant connection of an insertion end (2) of a tube (3) to a connection sleeve (4), with a retention ring (18) encompassing the insertion end (2) at the circumference and is disposed in an inner groove (12) of the connection sleeve (4), wherein the insertion end (2) projects beyond the retention ring (18) by an excess length (25) in the insertion direction of the tube, and a sealing ring (34), preferably a lip sealing ring (35), which circumferentially encompasses the insertion end (2) is disposed in a ring groove (33), adjacent to the ring groove (12) and at a distance from it in the insertion direction of the tube end, and the connection sleeve (4) has a slit-shaped wall cutout (13) that allows radial insertion of the retention ring, over a partial region of the circumference of the sleeve section (11) that has the inner groove (12), wherein the wall cutout (13) extends over a cross-section sector whose inner angle is less than 180°.

40. Tube connection (1) according to claim 39, wherein the retention ring (18) is formed by a plastic ring that can be thermally connected with the insertion end (2) by means of a melting process, in which ring an electrical heating element (22) is disposed.

41. Tube connection (1) according to claim 39, wherein the retention ring (18) has a clamping ring (48) that can be laid into the inner groove (12) and set onto the insertion end (2) of the tube (3), which can be clamped onto the tube by means of a clamping device (49).

42. Tube connection (1) according to claim 39, wherein at least one bridge element (45) that spans the slit-shaped wall cutout (13) in the axial direction and is anchored on both sides of the wall cutout (13) of the sleeve section is provided.

43. Tube connection (1) according to claim 39, wherein a tangential flattened region (59) of the groove bottom of the inner groove (12) is provided.

44. Tube connection (1) according to claim 39, wherein narrowing of the wall cutout (13) is provided.

45. Tube connection (1) according to claim 42, wherein the bridge element (45) is releasably attached to the sleeve section, particularly screwed onto it.

46. Tube connection (1) according to claim 39, wherein the retention ring (18) is configured to be elastically deformable in the radial direction.

47. Tube connection (1) according to claim 39, wherein the retention ring (18) is provided with gearing-like retention means (39) on its inner circumference surface (38).

48. Tube connection (1) according to claim 47, wherein the retention means (39) are formed by molded-in elements molded into the retention ring (18), particularly high-strength elements that have a gearing on the inner circumference surface (38).

49. Tube connection (1) according to claim 48, wherein the retention means (39) consist of a material that has a higher strength as compared with the material of the retention ring (18), particularly of a metallic material.

50. Tube connection (1) according to claim 39, wherein the retention ring (18) is pressed or can be pressed against the outer tube circumference surface by way of a wedge-shaped bracing ring (41).

51. Tube connection (1) according to claim 50, wherein the bracing ring (41) is connected with the connection sleeve so as to be adjustable in the axial direction.

52. Tube connection (1) according to claim 50, wherein the wedge-shaped bracing ring (41) is attached by way of a flange and bracing screws (43) that project through it, and, in adjustable manner, in face-side threaded bores disposed in the connection sleeve.

53. Tube connection (1) according to claim 39, wherein the retention ring (18) is formed by arc ring segments.

54. Tube connection (1) according to claim 39, wherein the width (16) of the wall cutout (13) approximately corresponds to the width (17) of the inner groove (12).

55. Tube connection (1) according to claim 39, wherein the slit width (36) of the wall cutout (13) is smaller than the outside diameter (37) of the retention ring (18).

56. Tube connection (1) according to claim 39, wherein the sleeve section (11) is configured in tubular shape.

57. Tube connection (1) according to claim 39, wherein the sleeve section (11) has an oval or polygonal cross-sectional shape.

58. Tube connection (1) according to claim 39, wherein the retention ring (18) is configured in C shape.

59. Tube connection (1) according to claim 39, wherein the retention ring (18) has incisions that run radially over a partial region of its width (19), distributed over a circumference.

60. Tube connection (1) according to claim 39, wherein at least one tension anchor, e.g. screw that runs in the axial direction and connects a bead edge (44) with the sleeve section (11) is disposed in the region of the wall cutout (13).

61. Tube connection (1) according to claim 40, wherein the retention ring (18) with the sealing ring molded onto it is formed by a two-component injection-molded part.

62. Tube connection (1) according to claim 39, wherein the connection sleeve (4) is an integral part of a connection tube (46).

63. Tube connection (1) according to claim 39, wherein the connection sleeve (4) is an integral part of a housing (5) such as a valve housing, slide housing, and the like.

64. Tube connection (1) according to claim 39, wherein the housing (5) or connection tube is formed from plastic.

65. Tube connection (1) according to claim 39, wherein the housing (5) or connection tube consists of metallic material, particularly of a cast material.

66. Tube connection according to claim 39, wherein a spacer element (47) is provided between retention ring (18) and the face surface of the sleeve opening.

67. Tube connection according to claim 39, wherein the spacer element (47) is a ring, if necessary a slit ring, made of pressure-resistant material, preferably metal.

68. Tube connection according to claim 39, wherein the sealing ring is connected with the spacer element (47) and/or the retention ring (18).

69. Tube connection according to claim 39, wherein the clamping ring (48) has a ring groove (50) on its surface that faces the tube circumference surface, which groove has a shallowly rising wedge flank (51) and a steeply dropping stop flank (52) and a wedge-shaped ring (53) laid into it.

70. Tube connection according to claim 69, wherein the wedge-shaped ring (53) has a radius that can be changed in the radial direction and, for this purpose, preferably has a radial slit (54).

71. Tube connection according to claim 39, wherein the clamping device (49) has a clamping hoop (55) with a tension-screw connection (56), which can be laid around the clamping ring.

72. Tube connection according to claim 39, wherein the sealing ring (34) is formed from a material that demonstrates a greater elasticity as compared with the material of the retention ring (18).
